(19) United States
(12) Patent Application Publication
(10) Pub. No.: US 2024/0185743 A1
(43) Pub. Date: Jun. 6, 2024

(54) DIRECT THERMAL LABEL AND METHOD OF USE

(71) Applicant: GMERIX INC., Laval (CA)

(72) Inventors: Gourgen AMBARTSOUMIAN, Laval (CA); Somayeh Hosseini RAD, Laval (CA); Ali Mohammad RABEA, Laval (CA)

(21) Appl. No.: 18/552,526

(22) PCT Filed: Mar. 28, 2022
(86) PCT No.: PCT/IB2022/052848

§ 371 Date: Sep. 26, 2023

Related U.S. Application Data
(60) Provisional application No. 63/166,598, filed on Mar. 26, 2021.

(51) Int. Cl. G09F 3/00; G09F 3/02; G09F 3/10

(52) U.S. Cl. CPC G09F 3/0291; G09F 3/10; G09F 2003/0202; G09F 2003/0225; G09F 2003/023

(57) ABSTRACT

A label (20) may have a facestock (21). A direct thermal coating layer (21A) may be on the facestock (21), the direct thermal coating configured to selectively darken or change color by heat activation when direct thermal printed. A layer of adhesive (22) may be provided, the direct thermal coating layer (21A) being between the facestock (21) and the layer of adhesive (22).

### CROSS-REFERENCE TO RELATED APPLICATION

The present application claims the priority of U.S. Patent Application No. 63/166,598, filed on Mar. 26, 2021, and incorporated herein by reference.

### TECHNICAL FIELD

The present application relates to direct thermal printing and labels.

### BACKGROUND OF THE ART

Direct thermal printing involves the heating of selected areas or zones of a coating on a substrate in order to heat activate a dye by reaction with a matrix. According to FIG. 1 of the prior art, a typical direct thermal label 10 is shown as having a facestock 11, an adhesive 12 covering an undersurface of the facestock 11, an adhesive release layer 13, and a support liner 14, in one possible embodiment. The facestock 11 and adhesive 12 are united together and upon removal of the facestock 11 from the support liner 14, the adhesive 12 remains bonded to it. The removal of the facestock 11 from the support liner 14 may be facilitated by the adhesive release layer 13. The label 10 has a direct thermal coating 15, with dye and matrix, and possibly other compounds and/or substances. The print head A (a.k.a., printhead) is controlled to heat the desired areas of the direct thermal by contact and cause the reaction between dye and matrix, to blacken the areas. The blackened areas define the printing on the label 10. Direct thermal packaging or label materials are usually made from a paper or thin thermoplastic facestock film material. A thermoplastic is a type of plastic made up of a polymer resin(s) that softens when heated and hardens when cooled. Thermoplastics do not show any chemical property changes when heated or cooled multiple times.

Direct thermal printing is known to be cost effective, notably by not requiring a toner, a printer-applied ink or an inked ribbon in a printer, and thus printed by the relatively inexpensive printers used in direct thermal printing. However, areas printed with direct thermal may tend to fade over time, and may lack the capacity of resisting to substances such as solvents, oils, greases and/or chemicals in liquid or in other forms. The direct thermal print may also be damaged by physical contact resulting from friction, wear and tear, frequent touching, as well as by exposure to ultraviolet rays or radiation, daylight or sunlight, outdoor exposure, and other environmental and other conditions.

### SUMMARY

It is an aim of the present disclosure to provide a direct thermal label construction that addresses issues related to the prior art.

It is a further aim of the present disclosure to provide a method for manufacturing and/or using a direct thermal label.

In a first aspect of the present disclosure, there is provided a label comprising: a facestock; a direct thermal coating layer on the facestock, the direct thermal coating configured to selectively darken or change color by heat activation when direct thermal printed; and a layer of adhesive, wherein the direct thermal coating layer is between the facestock and the layer of adhesive.

Further in accordance with the first aspect, for example, the direct thermal coating includes a thermochromic ink and/or a thermochromic ink activation substance.

Still further in accordance with the first aspect, for example, the thermochromic ink is a leuco dye.

Still further in accordance with the first aspect, for example, a stabilizer may be present in the direct thermal coating to inhibit recrystallization of the leuco dye.

Still further in accordance with the first aspect, for example, the stabilizer is a phenol.

Still further in accordance with the first aspect, for example, a sensitizer may be in the direct thermal coating to optimize the colorization temperature and to facilitate mixing.

Still further in accordance with the first aspect, for example, the sensitizer is 1,2-bis-(3-methylphenoxy)ethane or 2-benzyloxynapthalene.

Still further in accordance with the first aspect, for example, the direct thermal coating includes at least one of the following substances: Bisphenol A (BPA), Bisphenol S (BPS), sulfonyl ureas, and/or zinc salts of substituted salicylic acids.

Still further in accordance with the first aspect, for example, the facestock has a thickness between 0.10 mil and 2.8 mil, inclusively.

Still further in accordance with the first aspect, for example, the facestock is made of a material selected from group of a thermoplastic film, a polymer, a synthetic film, acrylate, polyethylene terephthalate, polyolefin, polypropylene, oriented polypropylene, biaxially oriented polypropylene (BOPP), polyvinyl, polyethylene, polyamides, nylon, polyimide, or polystyrene.

Still further in accordance with the first aspect, for example, the facestock is made of a thermoset material.

Still further in accordance with the first aspect, for example, a wireless communication component may be in the label.

Still further in accordance with the first aspect, for example, a release liner may be provided upon which the adhesive layer is releasably adhered.

Still further in accordance with the first aspect, for example, the release liner includes an adhesive release layer and a support liner, the adhesive release layer being between the adhesive layer and the support liner.

Still further in accordance with the first aspect, for example, another facestock may be adhered to an underside of the layer of adhesive.

Still further in accordance with the first aspect, for example, the other facestock is thicker than the facestock.

In accordance with a second aspect of the present disclosure, there is provided a label comprising: a facestock, having a top surface and an undersurface; and a direct thermal coating layer on undersurface of the facestock, the direct thermal coating configured to selectively darken or change color by heat activation when direct thermal printed; wherein the direct thermal coating layer is between the facestock and an object to which the label is secured.

In accordance with a third aspect of the present disclosure, there is provided a method for fabricating a direct thermal label comprising applying a direct thermal coating on a surface of a facestock; and applying a layer of adhesive directly onto the direct thermal coating; wherein the direct thermal coating layer is between the facestock and the layer of adhesive.

In accordance with a fourth aspect of the present disclosure, there is provided method for using a direct thermal label comprising: obtaining a label with a direct thermal coating layer shielded by a facestock; heat activating selected zones of the direct thermal coating layer through the facestock to darken the selected zones; and adhering the label with the selected zones darkened to an object such that the direct thermal coating layer is between the facestock and the object.

In accordance with a fifth aspect of the present disclosure, there is provided method for fabricating a direct thermal label comprising: applying a direct thermal coating on a surface of a facestock; applying at least one barrier layer on the direct thermal coating; and applying a layer of adhesive directly onto the at least one barrier layer; wherein the direct thermal coating layer is between the facestock and the layer at least one barrier layer.

### DESCRIPTION OF THE DRAWINGS

FIG. 1 is a schematic view of a sequence of a direct thermal label prior to printing and followed by a printing thereof in accordance with the prior art;

FIG. 2 is a schematic view of a portion of a direct thermal label in accordance with a variant of the present disclosure;

FIG. 3A is a schematic view of the direct thermal label in accordance with a variant of the present disclosure;

FIG. 3B is a schematic view of the direct thermal label in accordance with a variant of the present disclosure, with a barrier film;

FIG. 4 is a schematic view of a method for printing the direct thermal label of FIG. 3A;

FIG. 5 is a schematic view of the direct thermal label of FIG. 4, with release liner removed;

FIG. 6 is a schematic view of the direct thermal label of FIG. 4, on a substrate;

FIG. 7A is a schematic view of the direct thermal label in accordance with a variant of the present disclosure, with a second facestock;

FIG. 7B is a schematic view of the direct thermal label in accordance with a variant of the present disclosure, with a second facestock and barrier film;

FIG. 8 is a schematic view of a method for printing the direct thermal label of FIG. 7A;

FIG. 9 is a schematic view of the direct thermal label of FIG. 7A, with release liner removed;

FIG. 10 is a schematic view of the direct thermal label of FIG. 7A on a substrate;

FIG. 11A is a schematic view of the direct thermal label in accordance with a variant of the present disclosure, with a second facestock and a varnish or coating;

FIG. 11B is a schematic view of the direct thermal label in accordance with a variant of the present disclosure, with a second facestock, varnish/coating and barrier film;

FIG. 12 is a schematic view of a method for printing the direct thermal label of FIG. 11B;

FIG. 13 is a schematic view of the direct thermal label of FIG. 11B, with release liner removed; and

FIG. 14 is a schematic view of the direct thermal label of FIG. 11B on a substrate.

### DETAILED DESCRIPTION

Referring to the drawings and more particularly to FIGS. 2, 3A and 3B, a direct thermal label in accordance with a variant of the present disclosure is generally shown at 20. The expression “direct thermal” is used as a moniker to describe the nature of the label 20, i.e., a label that may be printed with direct thermal printers. Direct thermal printing uses chemically treated, heat-sensitive media that blackens or changes color when it passes under the thermal printhead, for instance by conduction. The label 20 may have a facestock 21, a direct thermal coating 21A, an optional barrier layer 21B (FIG. 3B), an adhesive 22 on an undersurface of the direct thermal coating 21A or of the barrier layer 21B, an adhesive release layer 23, and/or a support liner 24, in one possible embodiment. FIG. 2 illustrates that the direct thermal coating 21A is first applied to the facestock 21, and then, as in FIG. 3A, the adhesive 22 may be applied to the direct thermal coating 21A, or on the barrier layer 21B as in FIG. 3B. In a variant that is applicable to all constructions of the label 20 described herein, it is contemplated to use a surface treatment on the underside of the facestock 21 to help adhesion of the direct thermal coating 21A to the facestock 21. Moreover, surface treatment of the facestock 21 on either side or on both sides, such as corona treatment, plasma treatment, flame treatment, or chemical treatment is also contemplated, further to enhance adhesion capability. A combination of surface treatment with adhesion promoting treatments is contemplated. The barrier coating or a layer 21B may optionally be present between the direct thermal coating 21A and the adhesive 22 to prevent contamination of the direct thermal coating 21A, for instance by the adhesive. The barrier layer 21B may be a single layer, a bi-layer, a multi-layer. For example, the direct thermal coating 21A may be applied as a liquid onto a surface of the facestock 21. Once dried or cured so as to form a direct thermal coating layer 21A, the adhesive 22 may be applied directly onto the direct thermal coating layer 21A.

The label 20 is on a release liner, that may include the adhesive release layer 23 on the support liner 24. The expression label 20 is used for all variants described herein, and includes the various layers, coatings, etc described herein, and this includes the release liner (that may include the adhesive release layer 23 on the support liner 24), even though the release liner is removed and discarded when the removable label portion of the label 20 is adhered to an object. The label 20, once removed from the release liner, may still be referred to as label 20, and can be also described as detached label 20, or detachable label 20. In another interpretation, it could be said that the release liner, if present (it is optional in all of the embodiments described herein), may not be part of the label 20. However, for consistency, the release liner will be described as being part of the label 20. Moreover, one release liner could be used with multiple separate removable label portions. The release liner may be without the adhesive release layer 23, for example with the support liner 24 having a low adherence surface in contact with the adhesive 22. The adhesive release layer 23 may be silicone based, non-silicone based, solvent-free. The release liner, i.e., the support liner 24 and optionally the adhesive release layer 23 on it can be made of any polymer based or paper based materials. Examples of polymer based film liners include thermoplastic films such as polyethylene terephthalate (PET), polyolefin, polypropylene, oriented polypropylene, biaxially oriented polypropylene (BOPP), polyester, polyvinyl, polyethylene, High Density Polyethylene (HDPE), Low Density Polyethylene (LDPE), polystyrene, synthetic paper, silicone rubber, nylon, polyamide, polyimide, mineral-based synthetic film, acrylate, compostable, biodegradable films and similar polymer based materials, as well as any composite materials or any combination thereof. The thickness of the polymer based support liner 24 can be between 0.5 mil and 12.0 mil. In another embodiment, the thickness of the polymer based support liner 24 can be between 0.8 mil and 2.0 mil. As another embodiment, the thickness of the polymer based support liner 24 can be between 0.9 mil and 1.8 mil. As another embodiment, the thickness of the polymer based support liner 24 can be between 1.1 mil and 1.6 mil. Paper based support liners 24 may include but are not limited to: Clay Coated Kraft paper, Super Calendered Kraft Paper, Glassines, Polyethylene Coated Kraft Papers such as LDPE, MDPE, HDPE coated Kraft Papers, etc. A number of release liners mentioned above are commercially available from Laufenberg GmbH (Krefeld-Hüls, Germany) and other companies. The thickness of the paper based support liner 24 can be between 1.0 mil and 12.0 mil. As a preferred embodiment, the thickness of the paper based support liner 24 may be between 2.2 mil and 3.6 mil. As another embodiment, the thickness of the paper based support liner 24 can be between 2.0 mil and 2.6 mil. As another embodiment, the thickness of the paper based support liner 24 can be between 2.3 mil and 6.0 mil.

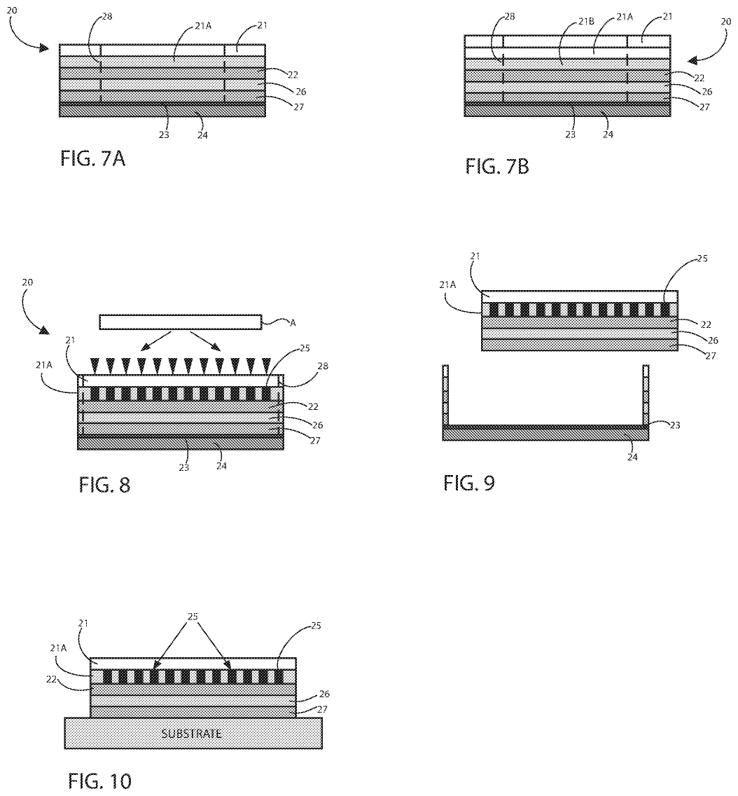

In an embodiment the label 20 may be without a release liner and wound on itself as a self-wound tape. In the latter case the adhesive is harbored on the surface of the facestock 21 of the coil underneath. In such instances the facestock 21 may have some release coating on its surface such as a layer including silicone, fluorosilicone, or non-silicone release coating(s). As in FIG. 5, the facestock 21, direct thermal coating 21A and adhesive 22 may be pulled out of engagement with the support liner 24, for instance as assisted by the adhesive release layer 23 if present. The facestock 21 may then be adhered to an object by way of the adhesive 22, as in FIG. 6. Instead of being adhered to a substrate, the facestock 21 can be adhered to another facestock by the way of the adhesive 22, as described below with reference to FIGS. 7A to 14, so as to act as a lamination of another label material or as a lamination of a non-adhesive tag material or as a lamination of any surface. In the figures, the support liner 24 is shown as being the same width as the facestock 21 of the label 20. However, it is possible to have part of the waste part of the facestock 21 removed (e.g., after die-cuts) from around the removable label portion of the label 20, such that the support liner 24 has greater width than the removable label portion of the label 20.

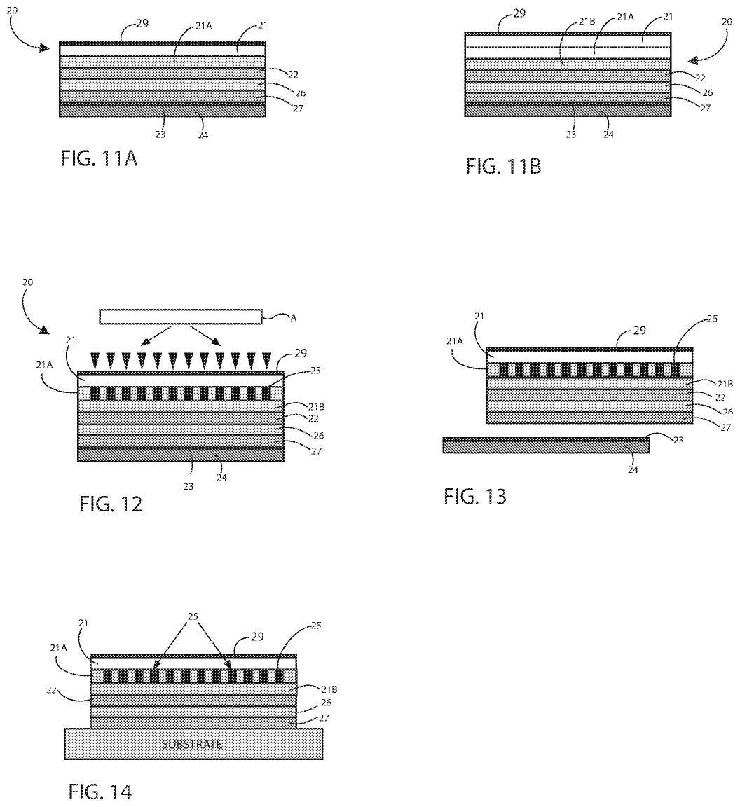

The facestock 21 may be made of any appropriate materials, such as polymer, synthetic film, thermoplastic or thermoset film such as a polyethylene terephthalate (PET), polyolefin, polypropylene, oriented polypropylene, biaxially oriented polypropylene (BOPP), polyester, polyvinyl, acrylate polyethylene, High Density Polyethylene (HDPE), Low Density Polyethylene (LDPE), polystyrene, synthetic paper, silicone rubber, polyamide (nylon), polyimide, mineral-based synthetic film, compostable, biodegradable films and similar polymer based materials, etc, as well as any composite materials or combination of materials comprising monomers or polymers. According to an embodiment, the facestock 21 has thickness between 0.10 mil-0.30 mil, inclusively. Such small thicknesses may facilitate heat conduction therethrough to activate the dyes in the direct thermal coating 21A. According to another embodiment, the facestock 21 has a thickness between 0.10 mil-2.8 mil inclusively, although it may also be thinner or thicker. In another embodiment, the thickness of the facestock 21 is between 0.20 mil-0.4 mil inclusively. In another embodiment, the thickness of the facestock 21 is between 0.25 mil-0.60 mil inclusively. In another embodiment, the thickness of the facestock 21 is between 0.30 mil-0.90 mil inclusively. The label 20 may include an ink layer, top coat, varnish or any other type of coating over the facestock 21. For example, the ink layer. varnish, top coat, etc may be provided to avoid direct contact between the printhead and a polymeric material of the facestock 21, as in some instances the heat may affect the polymeric material. For example, FIGS. 11A and 11B show one such layer of varnish. However, this is optional as some of the polymeric materials listed above may not be affected by temperature ranges of the printhead. The ink layer or varnish or the topcoat may be water based, solvent based, UV curable, LED-UV curable, EB curable, heat-curable, Infra-red curable, curable to any type of radiation, 100% solid topcoat, etc.

In another embodiment, the direct thermal coating 21A may be transparent, opaque, or translucent or may comprise a colorant or ink to have a colored background. It may include some adhesion promoter as part of the formulation. Other thermochromic inks can be used the same way for other applications. In another embodiment, the facestock 21 may comprise an additional layer of a topcoat. The facestock 21 may be transparent in its entirety or in the region of thermal printing, or have different degrees of opacity and transparency, for printing to be visible through the facestock 21. Yet in another embodiment, the facestock 21 may be devoid of adhesive 22 and support liner 24, for the facestock 21 to be used as a non-adhesive material in a roll, sheet, tag or a fanfold format for printing where the printhead is contacting the top surface of the facestock 21 without any direct contact with the direct thermal coating 21A. In other words, the heat travels through the facestock 21 in order to create the image in the direct thermal coating 21A. The facestock 21 may be a static cling film or any film coated with coating that provides static cling capabilities on a support liner without an adhesive (in this case the direct thermal ink will be between the facestock 21 and the liner 24). In a variant, the static cling film may be self wound without a support liner. In another embodiment, the direct thermal layer 21A may be sandwiched between 2 static cling facestocks, such as 21 and 26 described below, without the need to have adhesives 22 and/or 27. The label 20 with such a facestock 21 may be attached to surfaces through static/static-cling. A similar implementation of direct thermal layer being sandwiched between two non static cling facestocks without the need to have adhesives 22 or 27 is contemplated, such a label 20 being used for example as a non-adhesive tag material. The label 20 may be in any format such as a sheet, a strip, a roll, fanfold. When in a roll, the direct thermal label 20 is in an elongated strip that is wound on itself. When the label 20 is in a self-wound configuration without a support liner, the top surface of the facestock 21 may be coated with an adhesive release compound such as a coating that may include silicone, fluorosilicone, or a non-silicone release. In the latter case, the adhesive 22 may be harboured on the top surface of the facestock 21 and released from it upon unwinding the label 20. Another embodiment for the label 20 features a label and/or uncut label material without the adhesive release layer 23. Another embodiment for the label 20 features a support liner 24 (with or without layer 23) shared by numerous removable label portions resulting in numerous detached labels 20, such as a sheet of support liner 24 with a plurality of detachable labels 20. The label 20 may have any appropriate shape, including round, square, rectangular, to name but a few of the possibilities. Moreover, a plurality of the labels 20 may be interconnected in a sheet, roll, etc, for example with tear-off perforations or cuts.

The direct thermal coating 21A is the layer/portion of the label 20 with dye and matrix. For example, the direct thermal coating 21A includes a thermochromic ink and/or a thermochromic ink activation substance. The direct thermal coating 21A is heat sensitive as it reacts to heat to darken or change the color. Zones or surfaces are selectively heated to darken by contact with the printhead, these zones contrasting with the color of the facestock 21 and constituting the printing on the label 20. According to an embodiment, a thermochromic ink of the coating 21A is a leuco dye. These dyes have a colorless leuco form when crystalline in a PH neutral environment, and become colored when exposed to an acid which is called developer. The non-limitative examples of the most commonly used dyes are spirolactones, fluorans, spiropyrans, and fulgides. When in a heated state, the acid melts and the interaction between the acid and the dye causes the dye to change into its color form. Examples of acids suitable for thermochromic materials are octadecylphosphonic acid, phenols, e.g., Bisphenol A (BPA) and Bisphenol S (BPS). Other suitable acidic substances can be used as developers for leuco dyes (sulfonyl ureas, zinc salts of substituted salicylic acids, etc.). To optimize the colorization temperature and to facilitate mixing, sensitizers can optionally be added to the direct thermal coating 21A, such as 1,2-bis-(3-methylphenoxy)ethane or 2-benzyloxynapthalene. These ethers are solvents for leuco dyes and developers, and facilitate color formation at a specific temperature. To stabilize the color formed by the leuco dye, developer and sensitizer, a stabilizer may be added to the direct thermal coating 21A prior to application on the label 20. As a non-limitative example, stabilizers may be phenols that inhibit recrystallization of the dye and developer, thereby stabilizing the printed image. Most of the component are usually microencapsulated in a protective coating to protect the content from undesired effects caused by the components. Upon heating, the structure of the microcapsules disintegrates causing the reaction between the components resulting the darkening. The above described technology is presented as an example, and not all constituents thereof are required to be present in the direct thermal coating 21A in order to achieve a thermal printing. For example, the direct thermal coating 21A might be activated without a sensitizer or stabilizer or both. Different types of thermochromic inks and developers can be used. The above described label 20 can be used with other types of thermochromic inks and is not limited to only the specific variants described. The direct thermal label 20 can be applicable in any robotic, automation, printing, peeling and label and tape application devices and will cover any heat source beyond a printhead that is capable of activating the thermochromic and/or leuco-dye system.

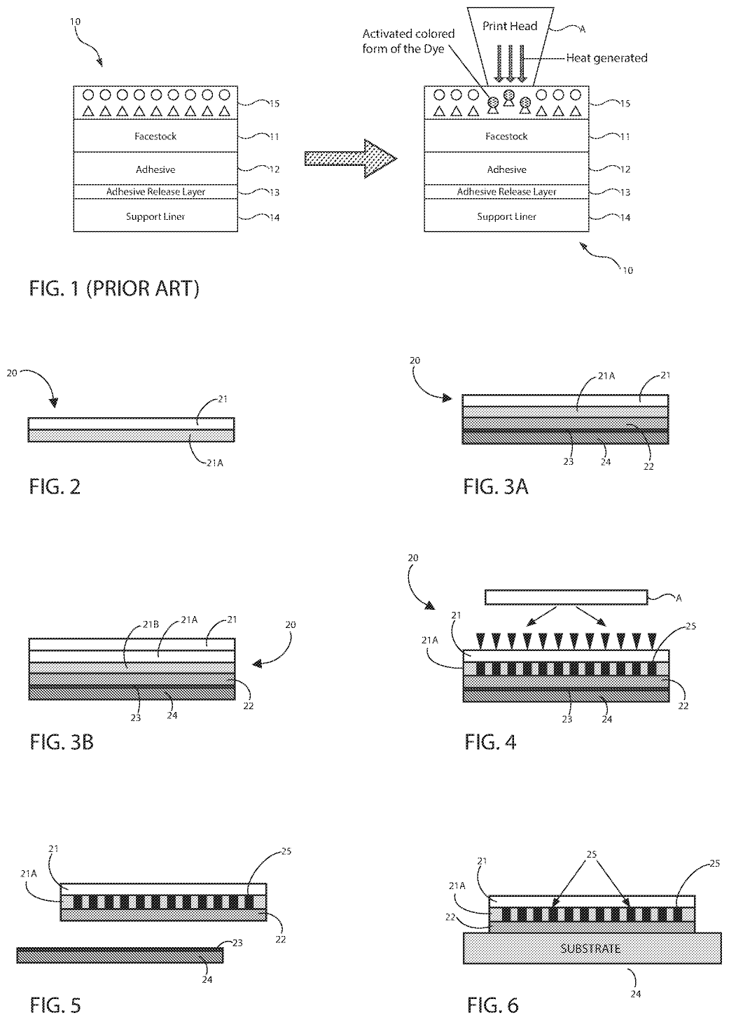

Referring to FIGS. 3A, 3B and 4, the label 20 is shown in its ready-for-printing condition. In FIGS. 3A and 3B, the label 20 is blank meaning there has been no heat activation of the direct thermal coating 21A—some data, image, graphics, logo, or markings may already present through other printing. The direct thermal coating 21A is thus shielded by the facestock 21. When print head A is applied to the label 20, it may heat the selected zones of the direct thermal coating 21A through the facestock 21. The facestock 21 does not lose its shielding properties in spite of the heating with the direct thermal printer A. As shown in FIG. 4, printing 25 in the direct thermal coating 21A results from the exposure to heat from the print head A, moving into contact with the label 20 in a similar manner as in FIG. 1. Though shown schematically, the printing 25 may take any appropriate form, such as characters (letters, numbers, codes), symbols, ornaments, codes (e.g., QR code, bar code), among other possibilities. The printing 25 may be any type of information such as serialized numbers, serialized text, lettering, alphanumerical characters or serialized barcodes, random numbers, random barcodes, random alphanumeric data, random text or it may be non-variable information. The printing 25 may be due to the release of leuco-dye.

Advantageously, the direct thermal coating layer 21A is shielded by the facestock 21. Moreover, once the support liner 24 with release layer 23 is removed as in FIG. 5, and the label 20 is adhered to a surface as in FIG. 6, the direct thermal coating layer 21A is sandwiched between the facestock 21 and the surface (via the layer of adhesive 22, if present). Accordingly, the direct thermal coating layer 21A may not be exposed to the environment, e.g., air, solvents, alcohol, chemicals, oil, grease, light, UV rays, etc. This may reduce the rate of fading of the printing 25, as the facestock 21 shields the direct thermal coating layer 21A from air, solvents, alcohol, chemicals, oil, grease, light, UV rays, etc. Certain type of transparent polymer materials such as the ones comprising monomers and polymers of acrylate and methacrylate, polystyrene, or those comprising monomers, polymers, and UV absorbers have the capability of protecting against outdoor exposures such as sunlight and UV light and prevent discoloration or fading of the direct thermal print underneath the facestock 21. As an embodiment the facestock 21 is an acrylate. As another embodiment the facestock 21 is a polyester. Yet another embodiment the facestock 21 is a polypropylene, oriented polypropylene or biaxially-oriented polypropylene. Yet another embodiment the facestock 21 is a polyethylene. Yet another embodiment the facestock is a polyamide (nylon).

The facestock 21 of the label 20 must have the capacity of conducting heat sufficiently, for heat from the print head A to activate the dye in the direct thermal coating layer 21A. In an embodiment, this is achieved by having a given thickness for the facestock 21, that is small enough so as not impede substantially on heat conduction to the direct thermal coating layer 21A. According to an embodiment, the facestock 21 has thickness between 0.10 mil-0.30 mil, inclusively. According to another embodiment, the facestock 21 has a thickness between 0.10 mil-2.8 mil inclusively or between 2.5 and 72 microns, although it may also be thinner or thicker. Other ranges of values are contemplated. Direct thermal coating activation temperatures can affect the darkness of the print and its quality. In accordance with some variants of the present disclosure, when the print head A is at a temperature ranging from 50° C. to 300° C. resulted in suitable quality printing, for a thickness of the facestock 21 being within the ranges given above. As is common practice, printer settings may be adjusted to achieve different levels of darkness based on user preferences. In an embodiment, the activation temperature of direct thermal ink is between 50° C. and 300° C. In another embodiment, the activation temperature of the direct thermal ink is between 65° C. and 230° C. In another embodiment, the activation temperature of the direct thermal ink is between 75° C. and 180° C. In another embodiment, the activation temperature of the direct thermal ink is between 50° C. and 160° C.

Referring to FIG. 7A, another variant of the label 20 is shown. The label 20 of FIG. 7A shares components with the variants 20 described herein for FIGS. 2-6, whereby like elements will have like reference numerals, such as for the facestock 21, the direct thermal coating layer 21A, the barrier layer 21B, the layer of adhesive 22, the adhesive release layer 23, and/or the support liner 24, the support liner 24 and the adhesive release layer 23, if present, being known as release liner as in the other embodiments described herein. While these layers are shown as being present in the variants of FIGS. 7A and 7B, some of the layers may be optionally removed.

In addition to the various layers described above, the label 20 of FIG. 7A may have an additional facestock 26, also referred to as a facestock layer 26. The facestock 26 may include an additional layer of facestock as a lamination beneath the adhesive 27 (not illustrated). The facestock 21, also known as laminate, and the direct thermal coating 21A, optional barrier layer 21B, may be anchored to the facestock 26 by the adhesive layer 22. The adhesive 22 in any of the variants described in the present disclosure may be any type of pressure sensitive or non-pressure sensitive adhesive including but not limited to water-based, hotmelt, UV hotmelt, LED UV curable hotmelt, rubber based, solvent based, acrylic based, emulsion, latex, silicone, radiation curable adhesives such as UV curable, LED UV curable, heat-curable, Infrared curable, cross-linked or non-cross-linked adhesives, hot-stampable, cold-stampable, heat activated, etc. and any combination thereof. Permanent, ultra-permanent removable, ultra-removable, repositionable, biodegradable, biocompostable, or any other type of adhesives are contemplated. The facestock 26 may be made of any appropriate materials, such as monomer, polymer, synthetic film, thermoset or thermoplastic film such as an acrylate, polyethylene terephthalate (PET), polyolefin, polypropylene, oriented polypropylene, biaxially oriented polypropylene (BOPP), polyesters, polyvinyl, polyethylene, High Density Polyethylene (HDPE), Low Density Polyethylene (LDPE), polystyrene, synthetic paper, silicone rubber, nylon, polyamide, polyimide, mineral-based synthetic film, compostable, biodegradable films and similar polymer based materials, paper, cardboard, materials comprising cellulose fiber, cloth, tissue, woven fabric or non-woven fabric, metal foils such as aluminum foil, metallized films, Tyvek, etc, as well as any composite materials or any combination thereof. While the facestock 21 may be transparent, the facestock 26 may be opaque, transparent, translucent, as it does not need to be see-through as it is under the direct thermal coating 21A and its printing 25. Facestock 26 may be of any color, with color incorporated inside the facestock 26 itself or printed on its surface(s), the facestock 26 including any type of ink, coating or ink-receptive coating or treatment. Another layer of adhesive, shown as 27, is used to adhere the facestock 26 to the support liner 24, for instance with the presence of optional adhesive release layer 23. FIG. 7B shows a similar variant as in FIG. 7A, but with the presence of barrier coating or barrier layer 21B. The barrier coating or barrier layer 21B may be present as in FIG. 7B between the direct thermal coating 21A and the adhesive 22 to prevent contamination of the direct thermal coating 21A, for instance by the adhesive 22. Another implementation of the direct thermal labels shown in 7A and 7B may include an additional layer of adhesive under the liner 24, harbouring on an additional release liner, in a piggy-back application. In another embodiment, a wireless communication element such as an RFID (Radio Frequency Identification) or NFC (Near Field Communication) that is capable of transmitting and/or receiving data or information may be incorporated underneath of the facestock 26 or at other locations in the labels 20 described herein.

The label 20 of FIGS. 7A and 7B may be without the adhesive release layer 23, for example with the support liner 24 having a low adherence surface in contact with the adhesive 27. In an embodiment, the label 20 of FIGS. 7A and 7B may be devoid of the adhesive release layer 23, the support liner 24 and adhesive 27, for the label 20 to be used as a non-adhesive tag. As in FIG. 9, the facestock 21, direct thermal coating 21A, facestock 26 and adhesive 27 may be pulled out of engagement with the support liner 24, for instance as assisted by the adhesive release layer 23 if present. The facestock 26 may then be adhered to an object by way of the adhesive 27, as in FIG. 10. It can be observed in FIG. 9 that residual portions of the label 20 remain on the support liner 24, in the event that a cut 28 penetrates the label 20 all the way but excluding the release layer 23 and support liner 24. These residual portions may also have been removed before printing of the label 20, e.g., at manufacturing.

According to an embodiment, the facestock 26 provides additional thickness to the label 20, and may be thicker than the facestock 21. This may for example allow the top facestock 21 to be relatively thin, and hence limit its impeding of heat conduction. The additional thickness provided by the facestock 26 may facilitate the die cutting into the label 20, for instance as shown by 28. In a variant, the cuts penetrate the label 20 all the way to but excluding the release layer 23 and support liner 24. If the various layers leading to the support liner 24 do not combine to a sufficient thickness, the cutting of the label 20 may be difficult and may require cutting technologies with limited deployment. Accordingly, the presence of a facestock 26, in addition to the top facestock 21, may provide some structural support function. Accordingly, the facestock 26 may have a thickness between 0.20 mil-20.0 mil inclusively, although it may also be thinner or thicker. As a preferred embodiment the thickness of the facestock 26 is between 0.40 mil and 10.0 mil. As another preferred embodiment the thickness of the facestock 26 is between 0.50 mil and 3.8 mil. As another preferred embodiment the thickness of the facestock 26 is between 0.80 mil and 5.0 mil. The facestock 26 may have other printing on it including data, image, logo, color, background color, etc. Facestock 26 may have any type of layers or coatings such as varnish, topcoat, fusion, ink-receptive coating, surface treatments such as corona treatment (increasing surface energy of the material through ionized air using electrical field), plasma treatment, flame treatment, or chemical treatment, etc. The adhesive 27 may be of any type adhesive such as pressure-sensitive or non pressure sensitive including but not limited to water-based, hotmelt, UV hotmelt, rubber based, solvent based, acrylic based, emulsion, latex, silicone, radiation curable adhesives such as UV curable, LED UV curable, heat-curable, Infrared curable, cross-linked or non-cross-linked adhesives, hot-stampable, cold-stampable, heat activated, etc. and any combination thereof. Permanent, ultra-permanent removable, ultra-removable, repositionable, biodegradable, biocompostable, or any other type of adhesives are contemplated.

Referring to FIGS. 7A, 7B, the label 20 is shown in its ready-for-printing condition. In FIGS. 7A and 7B, the label 20 is blank meaning there has been no heat activation of the direct thermal coating 21A—some data may already present through other printing. The direct thermal coating 21A is thus shielded by the facestock 21. When print head A is applied to the label 20, it may heat the selected zones of the direct thermal coating 21A through the facestock 21. The facestock 21 does not lose its shielding properties in spite of the heating with the direct thermal printer A. As shown in FIG. 8, printing 25 in the direct thermal coating 21A results from the exposure to heat from the print head A, moving into contact with the label 20 as in FIG. 1. Though shown schematically, the printing 25 may take any appropriate form, such as characters (letters, numbers, codes), symbols, ornaments, codes (e.g., QR code, bar code), among other possibilities. The printing 25 may be a variable information such as serialized numbers, serialized text, lettering, alphanumerical characters or serialized barcodes, random numbers, random barcodes, random alphanumeric data, random text or it may be non-variable information. The printing 25 may be due to the released leuco-dye or thermochromic ink.

Advantageously, the direct thermal coating layer 21A is shielded by the facestock 21. Moreover, once the release layer 23 and support liner 24 is removed as in FIG. 9, and the label 20 is adhered to a surface as in FIG. 10, the direct thermal coating layer 21A is sandwiched between the facestocks 21 and 26.

Referring to FIG. 11A, another variant of the label 20 is shown. The label 20 of FIG. 11A shares components with the variants 20 described herein for FIGS. 2-10, whereby like elements will have like reference numerals, such as for the facestock 21, the direct thermal coating layer 21A, the barrier layer 21B, the layer of adhesive 22, the adhesive release layer 23, the support liner 24, the second facestock 26, the adhesive layer 27 and/or cuts 28. While these layers are shown as being present in the variants of FIGS. 11A and 11B, some of the layers may be optionally removed.

In addition to the various layers described above, the label 20 of FIG. 11A may have varnish (e.g. any type of varnish, lacquer, topcoat, ink-receptive coating, silicone-comprising coating, release coating or any other type of coating) layer 29 or ink layer on top of the facestock 21. The ink layer or varnish may be provided to avoid direct contact between the printhead and a polymeric material of the facestock 21, as in some instances the heat may affect the polymeric material. FIG. 11B shows a similar variant as in FIG. 11A, but with the presence of barrier coating or barrier layer 21B. The barrier coating or barrier layer 21B may be present as in FIG. 11B between the direct thermal coating 21A and the adhesive 22 to prevent contamination of the direct thermal coating 21A, for instance by the adhesive 22.

The label 20 of FIGS. 11A and 11B may be without the adhesive release layer 23, for example with the support liner 24 having a low adherence surface in contact with the adhesive 27. As an embodiment label 20 of FIGS. 11A and 11B may be devoid of the adhesive release layer 23, the support liner 24 and adhesive 27, the label 20 of FIGS. 11A and 11B being used as a non-adhesive tag in such a construction. As in FIG. 13, the facestock 21 with varnish 29, direct thermal coating 21A, facestock 26 and adhesive 27 may be pulled out of engagement with the support liner 24, for instance as assisted by the adhesive release layer 23 if present. The facestock 26 may then be adhered to an object by way of the adhesive 27, as in FIG. 14.

Referring to FIGS. 11A, and 11B, the label 20 is shown in its ready-for-printing condition. In FIGS. 11A and 11B, the label 20 is blank meaning there has been no heat activation of the direct thermal coating 21A—some data may already present through other printing. The direct thermal coating 21A is thus shielded by the facestock 21. When print head A is applied to the label 20, it may heat the selected zones of the direct thermal coating 21A through the facestock 21, with the facestock 21 protected from the heat by the varnish 29 or like top coat. The facestock 21 does not lose its shielding properties in spite of the heating with the direct thermal printer A. As shown in FIG. 12, printing 25 in the direct thermal coating 21A results from the exposure to heat from the print head A, moving into contact with the label 20 as in FIG. 1. Though shown schematically, the printing 25 may take any appropriate form, such as characters (letters, numbers, codes), symbols, ornaments, codes (e.g., QR code, bar code), among other possibilities. The printing 25 may be a variable information such as serialized numbers, serialized text, lettering, alphanumerical characters or serialized barcodes, random numbers, random barcodes, random alphanumeric data, random text or it may be non-variable information. The printing 25 may be due to the released leuco-dye or thermochromic ink.

Therefore, in accordance with an embodiment, the label 20 has a facestock 21 adapted to be adhered to an object, via its adhesive layer 22, with a direct thermal coating layer 21A between the facestock 21 and the adhesive layer 22. A direct thermal coating 21A is on the facestock 21. The direct thermal coating 21A is configured to locally darken by heat activation when direct thermal printed. The object may be any type of object, such as objects or containers used in laboratories, including vials, tubes, blood collection tubes such as Vacutainers, sample collection tubes, microscope slides, tissue processing cassettes, plates, cell culture plates, microtiter plates, microarray plates, other types of plates, petri dishes, bottles, flasks, freezer boxes, cryogenic boxes, cryogenic straws, goblets other type of laboratory plastic containers, laboratory glassware and metal objects such as freezer racks, liquid nitrogen racks, canisters, etc. Furthermore, other objects, containers and surfaces in other industries such as construction, food, retail, warehousing, automotive, clothing, industrial, manufacturing, electrical, electronic, aviation, patient care, medical, pharmaceutical, office use, stationary, etc are covered by the present disclosure.

In accordance with another embodiment, a method is defined for fabricating a direct thermal label 20. The method for fabricating a direct thermal label may include at least: applying a direct thermal coating on a surface of a facestock; and applying a layer of adhesive directly onto the direct thermal coating; wherein the direct thermal coating layer is between the facestock and the layer of adhesive. In another embodiment, there may be a step of applying a barrier layer(s) of substance(s) or material(s) onto the direct thermal coating, such that the barrier layer is between the direct thermal layer and the adhesive, for instance to prevent the diffusion between the direct thermal coating and the adhesive or prevent the migration of adhesive into the direct thermal coating. As yet another embodiment there may be additional adhesive layer between the barrier film and the direct thermal layer. The barrier film can be opaque to provide a white or color background or it can be transparent, translucent or hazy or have any degree transparency or translucency or haziness. Maybe adding the use of extra layer of facestock 26 and adhesive 27. The barrier layer may be a separate film or a liquid coating applied and cured on the surface of the direct thermal coating 21A. The barrier layer can also be a liquid compound that can solidify or be cured and create a thin layer film. The barrier coating can be applied in multiple layers after curing each layer. The combination of having a barrier coating and a barrier film is contemplated. The term barrier layer may imply both the barrier coating or the barrier film.

In another embodiment the change of the color of the leuco dye can be activated by laser beam or light source or by a electromagnetic pulse or microwaves or any other factor that can trigger the color change.

Although in most cases the direct thermal printing process includes leuco dyes that darken upon heating we contemplate the use of other leuco dyes or thermochromic ink systems that can change into other colors such as transitioning from pink to grey or brown, or other colors such as blue, green, red, black, yellow, or any other shades, etc.

In accordance with another embodiment, a method for using a direct thermal label is provided. The label 20 is adhered with the selected zones darkened to an object. The method for using a direct thermal label may include: obtaining a label with a direct thermal coating layer shielded by a facestock; heat activating selected zones of the direct thermal coating layer through the facestock to darken the selected zones; and adhering the label with the selected zones darkened to an object such that the direct thermal coating layer is between the facestock and the object.

In a variant, the direct thermal coating layer 21A may include a substance or ingredient that can increase the affinity for or promote adhesion to facestock 21 or barrier film or barrier layer 21B if present. Moreover, the label 20 may have only the facestock 20 and the direct thermal coating layer 21A, if the direct thermal coating layer 21A has such affinity or adhesion characteristic, or if the facestock 20 has static cling properties. Such a label 20 may also include a support liner 24.

The direct thermal coating layer 21A may itself be the result of more than one coating layer, with subsequent layers applied after curing and/or drying of previous each layer. In another aspect, the facestock 26 may have an additional layer of a lamination under the adhesive 27. There are numerous variations in formulations of direct thermal coatings for the layer 21A, that may be commercially used or developed. All such formulations can be used for in using the method of constructing the label 20 described in the present disclosure. Any future formulations using thermochromic inks will be also within the scope of the present disclosure.

1. A label comprising:
a facestock;
a direct thermal coating layer on the facestock, the direct thermal coating configured to selectively darken or change color by heat activation when direct thermal printed; and
a layer of adhesive,
wherein the direct thermal coating layer is between the facestock and the layer of adhesive.

2. The label according to claim 1, wherein the direct thermal coating includes a thermochromic ink and/or a thermochromic ink activation substance.

3. The label according to claim 2, wherein the thermochromic ink is a leuco dye.

4. The label according to claim 3, further including a stabilizer in the direct thermal coating to inhibit recrystallization of the leuco dye.

5. The label according to claim 4, wherein the stabilizer is a phenol.

6. The label according to claim 5, further including a sensitizer in the direct thermal coating to optimize the colorization temperature and to facilitate mixing.

7. The label according to claim 6, wherein the sensitizer is 1,2-bis-(3-methylphenoxy)ethane or 2-benzyloxynapthalene.

8. The label according to claim 4, wherein the direct thermal coating includes at least one of the following substances: Bisphenol A (BPA), Bisphenol S (BPS), sulfonyl ureas, and/or zinc salts of substituted salicylic acids.

9. The label according to claim 1, wherein the facestock has a thickness between 0.10 mil and 2.8 mil, inclusively.

10. The label according to claim 1, wherein the facestock is made of a material selected from group of a thermoplastic film, a polymer, a synthetic film, acrylate, polyethylene terephthalate, polyolefin, polypropylene, oriented polypropylene, biaxially oriented polypropylene (BOPP), polyvinyl, polyethylene, polyamides, nylon, polyimide, or polystyrene.

11. The label according to claim 10, wherein the facestock is made of a thermoset material.

12. The label according to claim 1, further including a wireless communication component.

13. The label according to claim 1, further comprising a release liner upon which the adhesive layer is releasably adhered.

14. The label according to claim 13, wherein the release liner includes an adhesive release layer and a support liner, the adhesive release layer being between the adhesive layer and the support liner.

15. The label according to claim 1, including another facestock adhered to an underside of the layer of adhesive.

16. The label according to claim 15, wherein the other facestock is thicker than the facestock.

17. A label comprising:
a facestock, having a top surface and an undersurface; and
a direct thermal coating layer on undersurface of the facestock, the direct thermal coating configured to selectively darken or change color by heat activation when direct thermal printed;
wherein the direct thermal coating layer is between the facestock and an object to which the label is secured.

18. (canceled)

19. A method for using a direct thermal label comprising:
obtaining a label with a direct thermal coating layer shielded by a facestock;
heat activating selected zones of the direct thermal coating layer through the facestock to darken the selected zones; and
adhering the label with the selected zones darkened to an object such that the direct thermal coating layer is between the facestock and the object.

20. (canceled)
